(19) United States
(12) Patent Application Publication
(10) Pub. No.: US 2022/0109144 A1
(43) Pub. Date: Apr. 7, 2022

(54) NEGATIVE ELECTRODE FOR NON-AQUEOUS ELECTROLYTE SECONDARY BATTERY, AND NON-AQUEOUS ELECTROLYTE SECONDARY BATTERY COMPRISING THE SAME

(71) Applicant: HONDA MOTOR CO., LTD., Tokyo (JP)

(72) Inventors: Ken BABA, Saitama (JP); Takeshi FUJINO, Saitama (JP)

(21) Appl. No.: 17/449,452

(22) Filed: Sep. 29, 2021

(30) Foreign Application Priority Data
Oct. 5, 2020 (JP) 2020-168270

(51) Int. Cl. H01M 4/36; H01M 4/60

(52) U.S. Cl. CPC H01M 4/366; H01M 2004/027; H01M 4/604

(57) ABSTRACT

To provide a negative electrode for non-aqueous secondary battery, the negative electrode having excellent durability. A negative electrode for non-aqueous electrolyte secondary battery, wherein a multi-branched molecule is bonded to a surface of a negative electrode active material. Since direct contact of an electrolytic solution on a lithium insertion surface of a negative electrode active material is suppressed by disposing a multi-branched polymer on a surface of the negative electrode active material, it is possible to suppress decomposition of the electrolytic solution, whereby the growth of the SEI is suppressed.

Thereby, lithium consumption is reduced and long-term storage characteristics are improved, so that a non-aqueous electrolyte secondary battery having an improved capacity retention rate can be provided.

This application is based on and claims the benefit of priority from Japanese Patent Application No. 2020-168270, filed on 5 Oct. 2020, the content of which is incorporated herein by reference.

### BACKGROUND OF THE INVENTION

### Field of the Invention

The present invention relates to a negative electrode for non-aqueous electrolyte secondary battery and a non-aqueous electrolyte secondary battery including the negative electrode for non-aqueous electrolyte secondary battery.

### Related Art

In recent years, with the popularization of non-aqueous electrolyte secondary batteries, further high performance is desired.

Therefore, various techniques have been developed to enhance, the performance of the non-aqueous electrolyte secondary battery.

In lithium-ion secondary batteries, which are non-aqueous electrolyte secondary batteries, there is a known problem that solvent decomposition proceeds on surfaces of negative electrode particles, so that the solid electrolyte interface (SEI) grows, which decreases durability (capacity retention rate) because lithium in operation is consumed. Therefore, various means have been examined for improving durability.

Patent Document 1 discloses a method of improving durability by using an electrolytic solution additive to control formation of an SEI coating film or to control a composition of the SEI coating film.

Patent Document 1: Japanese Unexamined Patent Application, Publication No. 2019-192439

### SUMMARY OF THE INVENTION

However, when a concentration of the electrolytic solution additive is increased for further high durability, the conductivity of the electrolytic solution decreases, and battery output or low-temperature characteristics are lowered. Further, there is a problem that production efficiency is decreased, because a gas is generated in an SEI coating film forming stage, which necessitates longer production time. because defoaming and SEI forming reaction are repeated stepwise.

Further, although it has been attempted to stabilize the SEI by increasing the number of types of additives to improve the durability, there is a problem that, when the additive is increased, a coating film can be formed, but resistance is increased and output is lowered.

The present invention provides a negative electrode for non-aqueous electrolyte secondary battery having excellent durability and a non-aqueous electrolyte secondary battery including the negative electrode for non-aqueous electrolyte secondary battery.

In the present technology, a specific organic molecule is bonded to a negative electrode surface, whereby an interface is designed to the material so that an organic artificial SEI is formed.

In particular, when a multi-branched molecule is bonded, desolvation can be promoted, whereby decomposition of an electrolytic solution is suppressed, so that storage stability of the electrolytic solution is improved.

A first aspect of the present invention relates to a negative electrode for non-aqueous electrolyte secondary battery, the negative electrode comprising a negative electrode material comprising a negative electrode active material, a conductive aid, and a collector, in which a multi-branched molecule is bonded to a surface of the negative electrode material.

According to the invention of the first aspect, since direct contact of the electrolytic solution on a lithium insertion surface of the negative electrode active material is suppressed by disposing the multi-branched polymer, it is possible to suppress decomposition of the electrolytic solution, whereby the growth of the SEI is suppressed. Thereby, lithium consumption is reduced and long-term storage characteristics are improved, so that a negative electrode for non-aqueous electrolyte secondary battery having an improved capacity retention rate can be provided.

A second aspect of the present invention relates to the negative electrode for non-aqueous electrolyte secondary battery as described in the first aspect, in which the multi-branched molecule is constituted by having at least one compound selected from the group consisting of dendrons, dendrimers and hyperbranched polymers.

According to the invention of the second aspect, the multi-branched dendritic polymer is bonded to the outside of particles of the negative electrode active material, and an organic artificial SEI is formed, whereby the lithium insertion surface can be covered with the dendritic polymer. Thereby, since direct contact of the electrolytic solution on the lithium insertion surface is suppressed, it is possible to decrease decomposition of the electrolytic solution. Thus, the growth of the SEI is suppressed, thereby resulting in improved durability of the electrode and the electrolytic solution.

A third aspect of the present invention relates to the negative electrode for non-aqueous electrolyte secondary battery as described in the first or second aspect, in which the multi-branched molecule has a number average molecular weight of 300 or more and the multi-branched molecule has 4 or more molecular terminal portions in one molecule.

According to the invention of the third aspect, it is possible to sufficiently cover the lithium insertion surface on the surface of the negative electrode active material particles and to suppress the direct contact of the electrolytic solution on the lithium insertion surface, whereby it is possible to improve the durability of the electrode and the electrolytic solution.

A fourth aspect of the present invention relates to the negative electrode for non-aqueous electrolyte secondary battery as described in any one of the first to third aspects, in which the negative electrode active material has a functional group on a surface thereof, and in which the multi-branched molecule is bonded to the functional group.

According to the invention of the fourth aspect, the dendritic polymer can be immobilized on the surface of the negative electrode active material, whereby a more stable organic artificial SEI can be formed, resulting in improved durability.

A fifth aspect of the present invention relates to the negative electrode for non-aqueous electrolyte secondary battery as described in any one of the first to fourth aspects, in which a filling rate of the negative electrode active material in the negative electrode is 65% or more,

According to the invention of the fifth aspect, an SEI component can be controlled, whereby not only the durability but also the output and the charging performance of the battery can be improved.

Therefore, even when a density of the negative electrode is increased, reaction resistance at the interface of the active material can be suppressed, and an increase in resistance can be prevented.

Thus, it is possible to provide a negative electrode for non-aqueous electrolyte secondary battery whose energy density is increased.

A sixth aspect of the present, invention relates to a non-aqueous electrolyte secondary battery, including a negative electrode, in which the negative electrode is a negative electrode for non-aqueous electrolyte secondary battery as described in any one of the first to fifth aspects.

According to the invention of the sixth aspects, it is possible to provide a non-aqueous electrolyte secondary battery including an electrode and an electrolytic solution having improved durability.

A seventh aspect of the present invention relates to the non-aqueous electrolyte secondary battery as described in the sixth aspect, in which at least one compound selected from the group consisting of vinylene carbonate, fluoroethylene carbonate, and propane sultone is added to the electrolyte.

According to the invention of the seventh aspect, an electrolytic solution to which a compound that is reductively decomposable and easily forms an SEI coating film has been added is used in the battery as described in the sixth aspect, whereby the added compound is decomposed in preference to the electrolytic solution to form the SEI coating film of the negative electrode, so that the durability of the electrolytic solution is further improved.

By using the above-described compounds in combination with the electrode as described in the first to fifth aspects, it is possible to decrease the resistance of the electrolytic solution by reducing the number of types of additives while stabilizing the SEI.

### BRIEF DESCRIPTION OF THE DRAWINGS

FIG. 1 is a cross-sectional schematic view showing a negative electrode according to the present embodiment;

FIG. 2 is a graph showing the relationship between depth and composition of Example 3; and

FIG. 3 is a graph showing the relationship between depth and composition of Comparative Example 1.

### DETAILED DESCRIPTION OF THE INVENTION

Hereinafter, an embodiment of the present invention will be described with reference to the drawings. The contents of the present invention are not limited to the disclosures of the following embodiments.

### <Lithium-Ion Secondary Battery>

A lithium-ion secondary battery 100 of the present embodiment includes a positive electrode including a positive electrode material mixture layer formed on a positive electrode collector, a negative electrode 1 including a negative electrode material mixture layer 12 formed on a negative electrode collector, a separator for electrically insulating the positive electrode and the negative electrode 1 an electrolytic solution, and a container (not shown) for accommodating the positive electrode, the negative electrode 1 the separator, and the electrolytic solution.

In the container, the positive electrode material mixture layer and the negative electrode material mixture layer face each other with the separator interposed therebetween, and the electrolytic solution is stored below the positive electrode material mixture layer and the negative electrode material mixture layer.

Then, an end portion of the separator is immersed in the electrolytic solution,

### (Electrode Material Mixture Layer)

The positive electrode material mixture layer is composed of a positive electrode active material, a conductive aid, and a binder.

The negative electrode material mixture layer 12 is composed of a negative electrode active material 11, a conductive aid, and a binder.

In the material mixture layers of both the electrodes, innumerous particles of active materials constituting both the electrodes are disposed as aggregates.

### [Active Materials]

As the positive electrode active material, for example, a lithium composite oxide (LiNiₓCo_{y}Mn_{z}O₂ (x+y+z−1), LiNiₓCo_{y}Al_{z}O₂ (x+y+z=1)), lithium iron phosphate (LiFePO₄ (LFP)), or the like can be used.

One type of these may be used alone or two or more types thereof may be used in combination.

Examples of the negative electrode active material 11 include carbon powder (amorphous carbon), silica (SiOₓ), titanium composite oxide (Li₄Ti₅O₇, TiO₂, Nb₂TiO₇), tin composite oxide, a lithium alloy, metallic lithium, etc. and one or two or more thereof can be used.

As the carbon powder, one or more of soft carbon (easily graphitized carbon), hard carbon (non-graphitizable carbon), and graphite can be used.

### [Conductive Aid]

Examples of the conductive aid used in the positive electrode material mixture layer or the negative electrode material mixture layer 12 include carbon black such as acetylene black (AB) and Ketjen black (KB); a carbon material such as graphite powder; and conductive metal powder such as nickel powder.

One type of these may be used alone or two or more types thereof may be used in combination.

### [Binders]

Examples of the binder used in the positive electrode material mixture layer or the negative electrode material mixture layer 12 include cellulose-based polymers, fluorine-based resins, vinyl acetate copolymers, rubbers, etc. Specifically, as a binder when a solvent-based dispersion medium is used, polyvinylidene fluoride (PVDF), polyimide (PI), polyvinylidene chloride (PVDC), polyethylene oxide (PEO), and the like may be mentioned. As a binder when an aqueous dispersion medium is used, styrene butadiene rubber (SBR), acrylic acid-modified SBR resins (SBR-based latex), carboxymethyl-cellulose (CMC), polyvinyl alcohol (PVA), polytetrafluoroethylene (PTFE), hydroxypropylmethylcellulose (HPMC), a tetrafluoroethylene-hexafluoropropylene copolymer (FEP), and the like may be mentioned.

One type of these may be used alone or two or more types thereof may be used in combination.

### (Organic Artificial SEI Layer)

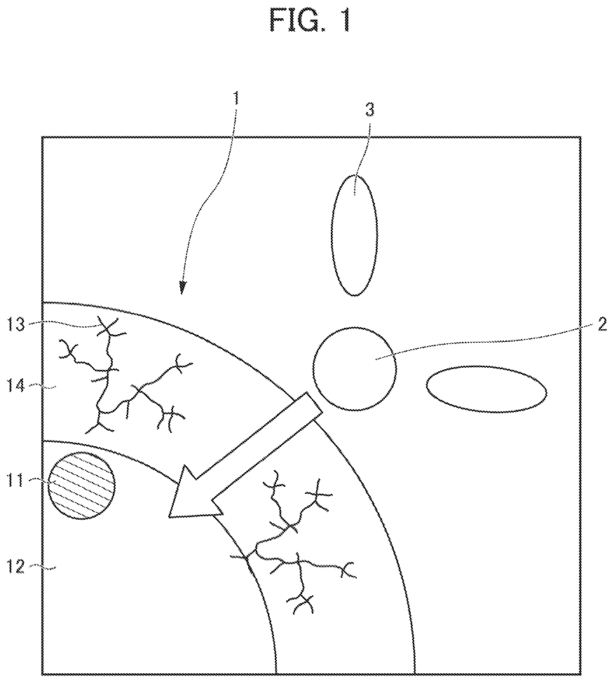

As shown in FIG. 1, the negative electrode 1 of the present embodiment has an organic artificial SEI layer 14 formed so as to cover the surface of a negative electrode material mixture layer 12.

The organic artificial SEI layer 14 is constituted by having multi-branched molecules 13 bonded to the particle surface of the negative electrode active material 11 constituting the negative electrode material mixture layer 12.

The multi-branched molecules 13 cover the surface of the negative electrode material mixture layer 12, whereby it is possible to prevent electrolytic solution molecules 3 from reaching the negative electrode material mixture layer 12 while allowing lithium ions to move between the negative electrode active material 11 and the electrolytic solution, thereby suppressing the decomposition of the electrolytic solution and improving the durability.

Furthermore, since it is possible to control the formation of the SEI or composition of the SEI on the negative electrode surface, output and charging performance of the lithium-ion secondary battery can be improved.

An interface formed between the multi-branched molecules 13 and the electrolyte of the present embodiment can suppress side reactions during reduction of lithium ions, and therefore the lithium reduction can be stably performed on the negative electrode 1.

The negative electrode 1 of the present embodiment is effective in a reaction in which lithium ions are reduced, and can be applied to lithium-ion secondary batteries, lithium metal batteries, or the like.

Further, the multi-branched molecules 13 may be bonded to, for example, a conductive aid surface or a collector surface, and in the same manner, side reactions during the reduction of lithium ions can be suppressed.

### [Multi-Branched Molecules]

The multi-branched molecule 13 is preferably composed of, for example, a dendritic polymer.

As the dendritic polymer, dendrons, dendrimers and hyperbranched polymers and the like may be used.

The number average molecular weight of the multi-branched molecule 13 is preferably 300 or more and 100,000 or less, and more preferably 800 or more and 10,000 or less.

When the number average molecular weight is within the above range, it is possible to sufficiently cover the lithium insertion surface on the surface of the negative electrode active material particles and to suppress direct contact of the electrolytic solution on the lithium insertion surface, whereby the durability of the electrode and the electrolytic solution can be improved.

Further, the multi-branched molecules 13 coat the negative electrode material mixture layer 12 to an extent that does not hinder the movement of lithium, and thus good lithium ion conductivity is exhibited.

It is preferable that the multi-branched molecule 13 has 4 or more molecular terminal portions in a molecule.

When the multi-branched molecule 13 has the molecular terminal portions in a number within the above range, and the molecular terminal portion has a specific functional group, a probability in which an adsorption group (the specific functional group) contacts with the negative electrode material mixture layer 12 increases, and an adsorption amount reaches an appropriate range. Thus, the adsorption group can firmly adsorb to and can be bonded to the negative electrode material mixture layer 12 and covers the surface thereof. The multi-branched molecule 13 more preferably has 4 or more and 64 or less molecular terminal portions, and most preferably has 8 or more hydroxy groups and at least 1 carboxy group.

The negative electrode material mixture layer 12 preferably has a hydroxy group or a carboxy group on the surface thereof.

Thereby, it is possible to condense with the multi-branched molecule 13 having a hydroxy group or a carboxy group to form the organic artificial SEI layer 14 on the surface.

The dendron which can be used in the present invention can be synthesised using an ordinary method, and in addition, a commercially available product can be used.

Such commercially available products can be obtained, for example, from Aldrich.

Examples of dendroris manufactured by Aldrich include: polyester-8-hydroxy-1-acetylenebis-MPA dendron, third generation (catalogue No.: 686646), polyester-16-hydroxy-1-acetylenebis-MPA dendron, fourth generation (catalogue No.: 686638), polyester-32-hydroxy-1-acetylenebis-MPA dendron, fifth generation (catalogue No.: 636611), polyester-8-hydroxy-1-carboxybis-MPA dendron, third generation (catalogue No.: 686670), polyester-16-hydroxy-1-carboxybis-MPA dendron, fourth generation (catalogue No.: 636662), and polyester-32-hydroxy-1-carboxybis-KPA dendron, and fifth generation (catalogue No.: 686654).

The dendrimers which can be used in the present invention can be synthesized using an ordinary method, and commercially available products are available from Aldrich.

For example, the following can be mentioned: polyamidoandne dendrimer, wherein the terminal is an amino group, ethylenediamine core, 0.0 generation (catalogue No.: 412363), polyamidoamine dendrimer, ethylenediamine core, 1.0 generation (catalogue No.: 412368), polyamidoamine dendrimer, ethylenediamine core, 2.0 generation (catalogue No.: 412406), polyamidoamine dendrimer, ethylenediamine core, 3.0 generation (catalogue No.: 412422), polyamidoamine dendrimer, ethylenediamine core, 4.0 generation (catalogue No.: 412446), polyamidoamine dendrimer, ethylenediamine core, 5.0 generation (catalogue No.: 536709), polyamidoamine dendrimer, ethylenediamine core, 6.0 generation (catalogue No.: 536717), polyamidoamine dendrimer, ethylenediamine core, 7.0 generation (catalogue No.: 536725), and the like.

In addition to those having a terminal amino group, those having a hydroxy group, a carboxy group, and a trialkoxysilyl group are available.

The dendrimers which car. be used in the present invention can be synthesized using an ordinary method, and commercially available products are available from Aldrich.

Examples thereof include hyperbranched bis-MPA polyester-16-hydroxy, second generation (catalogue No.: 686603), hyperbranched bis-MPA polyester-32-hydroxy, third generation (catalogue No.: 686581), hyperbranched bis-MPA polyester-64-hydroxy, fourth generation (catalogue No.: 636573), etc.

These terminal active groups may be provided with a substituent using any reaction,

A filling rate of the negative electrode active material 11 in the negative electrode is preferably 65% or more. Thereby, the electrode can have a high energy density, and it is possible to produce a high output lithium-ion battery or a downsized lithium-ion battery.

Conventionally, when the filling rate of particles of the negative electrode active material 11 was increased, there was a problem that the electrolytic solution molecules 3 permeated between particles of the negative electrode active material 11 and were decomposed inside the negative electrode material mixture layer 12 to form an SEI, whereby Interface resistance grew larger.

In the lithium-ion battery 100 of the present embodiment, intrusion of the electrolytic solution molecules 3 between the particles of the negative electrode active material 11 can be prevented by the organic artificial SEI layer 14, and an increase in the interface resistance can be prevented.

### (Collectors)

As a material for the positive electrode collector and the negative electrode collector, a foil or plate of copper, aluminum, nickel, titanium, or stainless steel; a carbon sheet a carbon nanotube sheet, or the like can be used.

The above materials may be used alone or, if necessary, a metal-clad foil made of two or more types of materials may be used.

The thickness of the positive electrode collector and that of the negative electrode collector are not particularly limited, but the thickness may be set to, for example, a range from 5 to 100 μm.

From the viewpoint of structure and improvement in performance the thickness of a positive electrode collector 2 and that of a negative electrode collector 5 are preferably set to a thickness ranging from 7 to 20 μm.

### (Separators)

The separator is not particularly limited, and examples thereof include a porous resin sheet (film, nonwoven fabric, and the like) made of a resin such as polyethylene (PE), polypropylene (PP), polyester, cellulose, polyamide, or the like.

### (Electrolytic Solutions)

As the electrolytic solution, a solution composed of a non-aqueous solvent and an electrolyte may be used.

The concentration of electrolyte is preferably in the range of 0.1 to 10 mol/L.

To the electrolytic solution, an additive containing at least one type of compound selected from the group consisting of vinylene carbonate, fluoroethylene carbonate and propane sultone may be added.

Thus, by using an electrolytic solution to which a compound that is reductiveiy decomposable and easily forms an SEI coating film is added, the added compound is decomposed in preference to the electrolytic solution to form an SEI coating film on the negative electrode, whereby durability of the electrolytic solution is further improved.

By using in combination with the negative electrode in which the organic artificial SEI layer 14 is formed by the multi-branched molecule 13, it is possible to reduce the number of types of the additives and lower the resistance of the electrolytic solution, while stabilizing the SEI.

### [Non-Aqueous Solvents]

The non-aqueous solvent contained in the electrolytic solution is not particularly limited, and examples thereof include aprotic solvents such as carbonates, esters, ethers, nitriles, sulfones, lactones, etc.

Specifically, the following can be mentioned: ethylene carbonate (EC), propylene carbonate (PC), diethyl carbonate (DEC), dimethyl carbonate (DMC), ethyl methyl carbonate (EMC), 1,2-dimethoxyethane (DME), 1,2-diethoxyethane (DEE), tetrahydrofuran (THF), 2-methyltetrahydrofuran, dioxane, 1,3-dioxolane, diethylene glycol dimethyl ether, ethylene glycol dimethyl ether, acetonitrile (AN), propionitrile, nitromethane, N,N-dimethylformamide (DMF), dimethyl sulfoxide, sulfolane, γ-butyrolactone, etc.

### [Electrolytes]

Examples of the electrolyte contained in the electrolytic solution include the following: LiPF₆, LiBF₄, LiClO₄, LiN (SO₂CF₃), LiN(SO₂C₂F₆)₂, LiCF₃SO₃, LiC₄F₉SO₃, LiC(SO₂CF₃)₃, LiF, LiCl, LiT, Li₂S, Li₃N, Li₃P, Li₁₀GeP₂S₁₂(LGPS), Li₃PS₄, Li₆PS₅Cl, Li₇P₂S₆I, LiₓPO_{y}N_{z} (x=2y+3z−5, LiPON), Li₇La₃Zr₂O₁₂ (LLZO), Li₃ₓLa_{2/3-z}TiO₃ (LLTO), Li₁₄ₓAlₓTi₂₋ₓ (PO₄)₃(0≤x≤1, LATP), Li_{1.5}Al_{0.5}Ge_{1.5} (PO₄)₃(LAGP), Li_{1+x+y}AlₓTi₂₋ₓSiyP_{3-y}O₁₂, Li_{1+x+y}Alₓ(Ti,Ge)₂₋ₓSi_{y}P_{3-y}O₁₂, Li₄₋₂ₓZnₓGeO₄ (LZSICOM), etc. Among them, LiPF₆, LiBF₄, or a mixture thereof is preferably used as the electrolyte.

Further, as the electrolytic solution, an ionic liquid or an ionic liquid containing a polymer including an aliphatic chain, such as polyethylene oxide (PEG), a polyvinylidene fluoride (PVDF) copolymer, etc. may be mentioned. The electrolytic solution containing an ionic liquid can flexibly cover a surface of a positive electrode active material or a negative electrode active material, and the ionic liquid is brought into contact with the surfaces of the positive electrode active material or the negative electrode active material 11 to form a site through which the ionic; liquid moves.

The present invention is not limited to the embodiment described above, and variations and modifications are included in the present invention as long as the object of the present invention can be achieved.

For example, the non-aqueous electrolyte secondary battery is a secondary battery (electricity storage device) using a non-aqueous electrolyte, such as an organic solvent, as the electrolyte. In addition to the lithium-ion secondary battery, a sodium ion secondary battery, a potassium ion secondary battery, a magnesium ion secondary battery, a calcium ion secondary battery, and the like are included.

The lithium-ion secondary battery means a non-aqueous electrolyte secondary battery whose main component is not water and which includes lithium-ions as a carrier responsible for electrical conductivity.

For example, a metal lithium battery, a lithium-polymer battery, a lithium all-solid-state battery, an air lithium-ion battery and the like fall within the lithium-ion secondary battery.

The same applies to other secondary batteries. Here, the non-aqueous electrolyte whose main component is not water means that the main component in the electrolyte is not water.

That is, the non-aqueous electrolyte is a known electrolyte that is used in non-aqueous electrolyte secondary batteries. This electrolyte can function as a secondary battery even when it includes a small amount of water but this adversely affects cycle characteristics, storage characteristics, and input/output characteristics of the secondary battery, and thus it is desirable that the electrolyte contains as little water as possible.

Realistically, the content of water in the electrolyte is preferably equal to or less than 5,000 ppm.

### EXAMPLES

Hereinafter, the contents of the present invention will be described in more detail based on the Examples.

The contents of the present invention are not limited to the description of the following Examples.

The positive electrodes and the negative electrodes of Examples 1 to 10 and Comparative Example 1 were prepared. The composition of the negative electrode and that of the positive electrode in each of the Examples and the Comparative Example are shown in Tables 1 and 3, respectively.

Further, details of the types of multi-branched molecules indicated in Table 1 are listed in Table 2.

Furthermore, the compositions of the electrolytic solutions shown in Table 1 are shown in Table 4.

### (Preparation of Positive Electrodes)

A conductive aid and polyvinylidene fluoride (PVDF) were mixed and dispersed with a planetary centrifugal mixer, then Li₁Ni_{0.6}Co_{0.2}Mn_{0.2}O₂ (NCM622) was added as the positive electrode active material and the obtained mixture was mixed using a planetary mixer.

Thereafter, N-methyl-N-pyrrolidinone (NMP) was added to prepare an electrode paste.

This electrode paste was applied to a collector made of Al, dried, then pressurized by a roll press, and then dried in a vacuum at 120° C. to prepare a positive electrode plate.

The electrode plate prepared was punched to 30 mm×40 mm and used.

The thickness of the positive electrode plate was set to 70 μm.

### (Preparation of Negative Electrodes)

Carboxymethyl cellulose (CMC) and a conductive aid were mixed and dispersed using a planetary mixer.

Thereafter, a negative electrode material described in each of the Examples described below was mixed and dispersed again using a planetary mixer.

Thereafter, a dispersion solvent and SBR were added and the negative electrode material was dispersed to prepare an electrode paste.

This electrode paste was applied to a collector made of Cu, dried, pressurized by a roll press, and dried in a vacuum at 100° C. to prepare a negative electrode plate.

The electrode plate prepared was punched to 34 mm×44 mm and used.

The thickness of the negative electrode plate was set to 90 μm.

### (Preparation of Negative Electrode Material)

In preparing the negative electrode material of Example 1, 96.3 parts by weight of graphite and 0.2 parts by weight of the multi-branched molecule compound of No. 1 indicated in Table 2 were weighed and stirred in an aqueous solution for 1 hour.

Thereafter, the resulting mixture was dried under a reduced pressure at 150° C. for 12 hours, and the negative electrode material in which organic molecules were bonded to the surface of the active material was obtained.

In preparing the negative electrode materials of Examples 2 to 10, likewise to Example 1, graphite and multi-branched molecule compounds were weighed by parts by weight as described in Table 1 and stirred in an aqueous solution for 1 hour.

Thereafter, each of the resulting mixtures was dried under a reduced pressure at 150° C. for 12 hours, and the negative electrode material in which organic molecules were bonded to the surface of the active material was obtained.

As the negative electrode material of Comparative Example 1, untreated graphite was used.

### (Preparation of Lithium-Ion Secondary Batteries)

Lithium-ion secondary batteries were manufactured in the following manner: an aluminum laminate for secondary batteries (manufactured by Dai Nippon Printing Co., Ltd.) was heat sealed to make a container in a pouch-like shape; into the container, a stack obtained by disposing a separator between the positive electrode and the negative electrode prepared above was introduced; and an electrolytic solution was injected to interfaces of the electrodes.

### <Evaluation>

The following evaluation was performed on the lithium-ion secondary batteries prepared using the electrodes of Examples 1 to 10 and Comparative Example 1 described above.

### [Initial Capacity]

Under the condition of 25° C., each of the lithium-ion secondary batteries was charged to 4.2 V at 0.2 C and then discharged to 2.5 V at 0.2 C.

This was repeated five times, and the discharge capacity at the time of the fifth discharge was taken as the initial capacity.

### [Initial Cell Internal Resistance Value]

The lithium-ion secondary battery after the initial capacity measurement was left to stand at the measurement temperature (25° C.) for 1 hour, then charged at 0.2 C to adjust a charge level (SOC (State of Charge)) to 50% and left to stand for 10 minutes.

Then, the lithium-ion secondary battery was subjected to pulse discharge at; a C rate of 0.5 C for 10 seconds, and a voltage at the time after 10 seconds discharge was measured.

Then, the voltage at the time after 10 seconds discharge was plotted with respect to the current at 0.5 C, with the horizontal axis being for the current value, and the vertical axis being for the voltage.

Next, after the battery was left to stand for 10 minutes, the SOC was reset to 50% by performing replenishment, and then the lithium-ion secondary battery was further left to stand for another 10 minutes.

Next, the operation described above was carried out at C rates of 1.0 C, 1.5 C, 2.0 C, 2.5 C, and 3.0 C, and the voltages at the time after 10 seconds discharge were plotted with respect to the current values at each C rate.

Then, slopes of approximation straight lines obtained by the least squares method from each plot were taken as the cell internal resistance values (Ω) of the lithium-ion secondary batteries obtained in the Examples.

Results are shown in Table 1.

### [Discharge Capacity After Storage Durability Test]

The storage durability test was carried out by charging the lithium-ion secondary batteries after measuring the initial cell internal resistance value to 4.2 V at 0.2 C and storing them at 4.5° C. for 84 days.

After storage, the lithium-ion secondary batteries were discharged to 2.5 V at 0.2 C under the condition of 25° C., and then charged to 4.2 V at 0.2 C again, and discharged to 2.5 V at 0.2 C.

Results are shown in Table 1.

Note that with respect to the discharge capacity obtained, a current value at which the discharge can be completed in 1 hour was assumed to be 1 C.

### [Internal Cell Resistance Value After Storage Durability Test]

Lithium-ion secondary batteries whose discharge capacity after storage durability test, had been measured were charged to 50% (of SOC (State of Charge)), as was the case when the initial cell internal resistance values were measured. The cell internal resistance values (Ω) after storage durability test, were obtained by the same method of measuring the initial cell internal resistance.

Results are indicated in Table 1.

### [Capacity Retention Rate After Storage Durability Test]

The rate of the discharge capacity (mAh) after storage durability test to the initial discharge capacity (mAh) was calculated, and the obtained rate was taken as a capacity retention rate (%) after storage durability test.

Results are indicated in Table 1.

[Resistance Increase Rate after Storage Durability Test]

The rate of the cell internal resistance value (Ω) after storage durability test to the initial cell internal resistance value (Ω) was calculated, and the rate was taken as a resistance increase rate after storage durability test (%).

Results are indicated in Table 1.

### [Surface Analysis of Cell Negative Electrode After Storage Durability Test]

With respect to Example 3 and Comparative Example 1, the cells after storage durability test were discharged to 2.5 V at 0.2 C.

The cells were disassembled, and the negative electrodes were drawn out, washed with a DMC solvent, and dried.

Thereafter, the electronic state of the surface of the negative electrodes were analyzed using X-ray photoelectron spectroscopy (hereinafter referred to as “XPS”) .

In the XPS-measurement, atomic-composition percentages (atom %) of elements adhering to each the negative electrode surface were detected.

A thickness of the coating film was calculated in terms of SiO₂ and defined as a depth at the time when oxygen reduced by half. Results are indicated in Table 5.

It could be seen that when the molecules were bonded, the thickness of SEI decreased, and the composition of the SEI and inorganic components thereof changed.

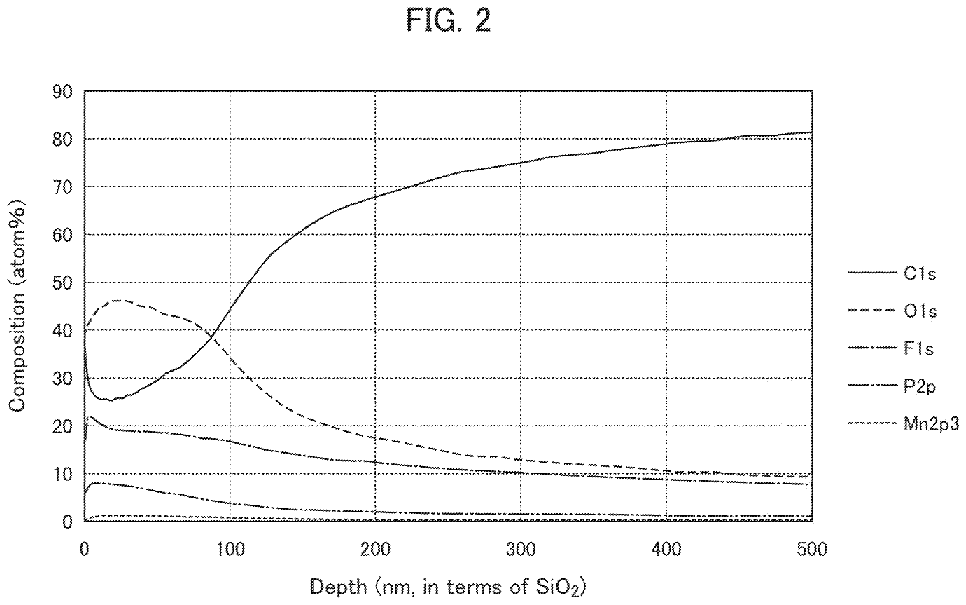

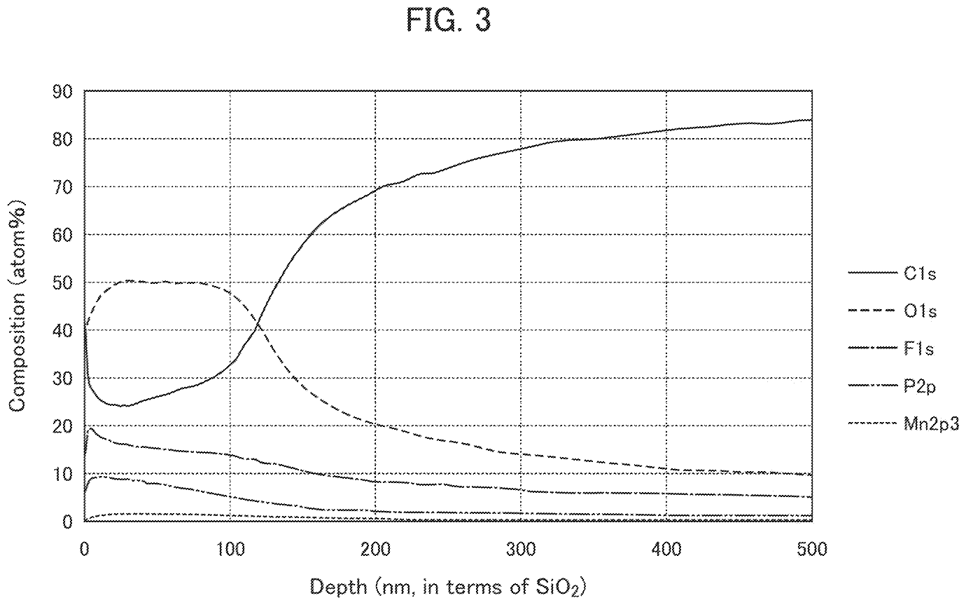

The relationships between the depth and the composition in Example 3 and Comparative Example 1 are indicated in FIGS. 2 and 3, respectively.

TABLE 1

| | | Example1 | Example2 | Example3 | Example4 | Example5 | Example6 |
|---|---|---|---|---|---|---|---|
| Type of multi-branched molecule | | No. 1 | No. 2 | No. 3 | No. 4 | No. 4 | No. 5 |
| Presence or absence of chemical bond | | Present | Present | Present | Present | Present | Present |
| Composition of electrolytic solution | | A | A | A | A | A | A |
| Composition of | Multi-branched molecule | 0.2 | 0.2 | 0.2 | 0.2 | 0.4 | 0.2 |
| negative | Negative electrode active material | 96.3 | 96.3 | 96.3 | 96.3 | 96.1 | 96.3 |
| electrode | Acetylene black | 1.0 | 1.0 | 1.0 | 1.0 | 1.0 | 1.0 |
| (wt %) | CMC | 1.0 | 1.0 | 1.0 | 1.0 | 1.0 | 1.0 |
| | SSR | 1.5 | 1.5 | 1.5 | 1.5 | 1.5 | 1.5 |
| Initial | Initial discharge capacity (mAh) | 42.3 | 43.4 | 43.0 | 43.4 | 43.2 | 43.3 |
| performance | Initial cell internal resistance value (Ω) | 0.7 | 0.7 | 0.7 | 0.7 | 0.8 | 0.7 |
| Performance | Capacity after storage durability test (mAh) | 39.0 | 39.6 | 39.9 | 40.2 | 40.5 | 40.0 |
| after storage | Cell internal resistance value after storage | 0.90 | 0.93 | 0.91 | 0.90 | 0.92 | 0.90 |
| durability test | durability test (Ω) | | | | | | |

| | | | | | | |
|---|---|---|---|---|---|---|
| Capacity retention rate after storage durability test (%) | 90.9 | 91.2 | 92.8 | 92.7 | 93.8 | 92.4 |
| Resistance increase rate after storage durability test (%) | 129 | 133 | 130 | 129 | 115 | 129 |

| | | | | | | Comparative |
|---|---|---|---|---|---|---|
| | | Example7 | Example8 | Example9 | Example10 | Example1 |
| Type of multi-branched molecule | | No. 6 | No. 7 | No. 5 | No. 4 | — |
| Presence or absence of chemical bond | | Present | Present | Present | Present | Absent |
| Composition of electrolytic solution | | A | A | A | B | A |
| Composition of | Multi-branched molecule | 0.2 | 0.2 | 0.1 | 0.2 | 0.0 |
| negative | Negative electrode active material | 96.3 | 96.3 | 96.4 | 96.3 | 96.5 |
| electrode | Acetylene black | 1.0 | 1.0 | 1.0 | 1.0 | 1.0 |
| (wt %) | CMC | 1.0 | 1.0 | 1.0 | 1.0 | 1.0 |
| | SSR | 1.5 | 1.5 | 1.5 | 1.5 | 1.5 |
| Initial | Initial discharge capacity (mAh) | 43.3 | 43.0 | 42.9 | 42.3 | 43.0 |
| performance | Initial cell internal resistance value (Ω) | 0.7 | 0.7 | 1.0 | 0.8 | 1.0 |
| Performance | Capacity after storage durability test (mAh) | 38.8 | 38.4 | 38.0 | 40.6 | 36.5 |
| after storage | Cell internal resistance value after storage | 0.92 | 0.90 | 1.30 | 1.00 | 1.39 |
| durability test | durability test (Ω) | | | | | |

| | | | | | |
|---|---|---|---|---|---|
| Capacity retention rate after storage durability test (%) | 89.6 | 89.3 | 88.6 | 94.9 | 84.9 |
| Resistance increase rate after storage durability test (%) | 131 | 129 | 130 | 125 | 139 |

TABLE 2
Composition of positive electrode (wt %)

| | |
|---|---|
| Positive | 94.0 |
| electrode active | |
| material | |
| Acetylene black | 4.1 |
| PVDF | 1.9 |

TABLE 3

| | | | Number of |
|---|---|---|---|
| | | | molecular |
| | | Number | terminal |
| | | average | portions |
| | | molecular | per |
| | Name of multi-branched molecule | weight | molecule |
| No. 1 | generation | 366 | 5 |
| No. 2 | Polyester-8-hydroxy-1-carboxybis-MPA | 831 | 9 |
| | dendron, third generation | | |
| No. 3 | generation | 1760 | 17 |
| No. 4 | generation | 3618 | 33 |
| No. 5 | dendrimer) | 1083 | 6 |
| No. 6 | dendrimer) | 10163 | 48 |
| No. 7 | PAMAM dendrimer, ethylenedyamine | 436 | 4 |
| | core, generation 0 | | |
| No. 8 | PAMAM dendrimer, ethylenedyamine | 106197 | 512 |
| | core, generation 6.5 solution | | |
| | 5 wt. % in methanol | | |

TABLE 4

| Electrolytic | |
|---|---|
| solution | Composition |
| A | 1.2M LiPF₆ + EC/EMC/DMC(3/3/4) + PS1% + VC1% |
| B | 1.0M LiPF₆ + 0.2M LiFSI EC/EMC/DMC(3/3/4) + |
| | PS1% + VC1% |

TABLE 5

| | Thickness |
|---|---|
| | of coating |
| | film (nm) |
| Example3 | 130 |
| Comparative | 160 |
| Example1 | |

From the results indicated in Table 1, it was confirmed that the lithium-ion secondary battery according to each of the Examples had a higher capacity retention rate after durability test and a lower resistance increase rate after durability test than the lithium-ion secondary battery of Comparative Example.

That is, it was confirmed that the lithium-ion secondary batteries of the respective Examples had excellent durability by having multi-branched molecules containing any one of dendrons, dendrimers and hyperbranched polymers on surfaces of the particles of the negative electrode active material.

### EXPLANATION OF REFERENCE NUMERALS

100 Lithium-ion secondary battery

1 Negative electrode

11 Negative electrode active material

12 Negative electrode material mixture layer

13 Multi-branched molecule

14 Organic artificial SEI layer

2 Lithium ion

3 Electrolytic solution molecule

What, is claimed is:

1. A negative electrode for non-aqueous electrolyte secondary battery, the negative electrode comprising a negative electrode material comprising a negative electrode active material, a conductive aid, and a collector,
wherein a multi-branched molecule is bonded to a surface of the negative electrode material.

2. The negative electrode for non-aqueous electrolyte secondary battery according to claim 1, wherein the multi-branched molecule is constituted by having at least one compound selected from the group consisting of dendrons, dendrimers and hyperbranched polymers.

3. The negative electrode for non-aqueous electrolyte secondary battery according to claim 1, wherein the multi-branched molecule has a number average molecular weight of 300 or more and the multi-branched molecule has 4 or more molecular terminal portions in one molecule.

4. The negative electrode for non-aqueous electrolyte secondary battery as described in claim 1,
wherein the negative electrode active material has a functional group on a surface thereof, and
wherein the multi-branched molecule is bonded to the functional group.

5. The negative electrode for non-aqueous electrolyte secondary battery according to claim 1,
wherein a filling rate of the negative electrode active material in the negative electrode is 65% or more.

6. A non-aqueous electrolyte secondary battery, comprising a negative electrode, wherein the negative electrode is constituted by having the negative electrode for non-aqueous electrolyte secondary battery according to claim 1.

7. The non-aqueous electrolyte secondary battery according to claim 6, wherein at least one compound selected from the group consisting of vinylene carbonate, fluoroethylene carbonate, and propane sultone is added to the electrolyte.
